(19) United States
(12) Patent Application Publication
(10) Pub. No.: US 2007/0138704 A1
(43) Pub. Date: Jun. 21, 2007

(54) Method of fabricating plastic substrate for liquid crystal display devices

(75) Inventors: Chung-Hao Chen, Hsinchu County (TW); Yi-An Sha, Taipei City (TW); Hsing-Lung Wang, Taoyuan County (TW); Kang-Hung Liu, Hsinchu (TW); Lung-Pin Hsin, Taichung City (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/481,509

(22) Filed: Jul. 6, 2006

(30) Foreign Application Priority Data
Dec. 21, 2005 (TW) TW94145527

(51) Int. Cl. B29C 71/00; B29C 71/02

(52) U.S. Cl. 264/345; 264/348

(57) ABSTRACT

A method of fabricating plastic substrates for a liquid crystal display device. A plastic substrate is provided. The plastic substrate is heated to a first temperature and maintain at the first temperature. Next, the plastic substrate is quenched to a second temperature, retaining microstructure of the plastic substrate from the first temperature.

### BACKGROUND OF THE INVENTION

1. Field of the Invention

The invention relates to a method for fabricating liquid crystal display (LCD) devices, and in particular to a method for fabricating a plastic substrate structure for LCD devices.

2. Description of the Related Art

Liquid crystal displays typically exhibit excellent characteristics such as low power consumption, light weight, and good outdoor reliability, and are therefore widely applied in portable computer, notebook, mobile phone, and personal digital assistants (PDA). Philips Inc. in Society for Information Display (SID) discloses that flexibility is improved when total thickness of the liquid crystal display is reduced. Generally, when total thickness of the display is less than 400 μm, the display becomes flexible to bendable.

Color filters are key parts of full color display devices. Conventional color filters are formed on thick, heavy, and brittle glass substrate, limiting application in display devices. Conversely, some attempts have been made to introduce transparent plastic substrates to small single color gray scale display devices. As requirements for full color display devices increase, however, thinner, lighter, and flexible transparent plastic substrates are required for liquid crystal display applications.

Plastic substrates, however, are not only limited to processing temperatures, but their dimensions are also affected by thermal processes, resulting in asymmetrical expansion and shrinkage. FIG. 1 is a schematic view illustrating asymmetrical expansion and shrinkage of a plastic substrate after thermal processes. More specifically, the axis along the conveyance of the plastic substrate 100 is defined as working axis dₓ, and the axis vertical to the working axis dₓ is defined as extension axis d_{y}. The working axis dₓ and extension axis d_{y} exhibit inconsistent expansion and shrinkage behavior after each thermal process, affecting precision of subsequent formation of color filters. Furthermore, plastic substrates tendency for humidity absorption can cause expansion related dislocation of color filters. Controlling expansion and shrinkage is thus important for plastic substrate LCD devices.

U.S. Pat. No. 6,737,338, the entirety of which is hereby incorporated by reference, discloses a method for forming high precision color filter patterns. By sputtering inorganic passivation layers on both sides of the plastic substrate, expansion of the plastic substrate is prevented. Application and exposure of the photoresist are also carefully controlled to achieve color filters with high accuracy of superpositioning on the plastic substrate.

Samsung Electronics in Society for Information Display (SID) 2004 discloses a method for forming PES substrates for LCD devices. An 180° C.-48 hr annealing process is performed on the PES substrate, and an organic passivation layer is sequentially deposited on thereon before thin film transistor (TFT) devices or color filters are formed. The precision of the TFT devices can reach 100 ppi. Conventional methods, however, require formation of inorganic passivation layers on the plastic substrates, higher and longer thermal process cycles, complicating production and decreasing yield.

### BRIEF SUMMARY OF THE INVENTION

A detailed description is given in the following embodiments with reference to the accompanying drawings.

A method for fabricating a transparent plastic substrate structure for a liquid crystal display device is provided. A plastic substrate is heated and maintained at near glass transition temperature, and then quenched to room temperature to prevent asymmetrical expansion and shrinkage of plastic substrate, thereby providing color filters with high accuracy of dimension, position, and superposition.

According to an embodiment of the invention, a method of fabricating a plastic substrate for a liquid crystal display device comprises providing a plastic substrate, heating the plastic substrate to a first temperature and maintaining the first temperature, and quenching the plastic substrate to a second temperature, retaining the microstructure of the plastic substrate under the first temperature.

According to another embodiment of the invention, a method of fabricating a plastic substrate for a liquid crystal display device comprises providing a plastic substrate, heating the plastic substrate to at least 5° below the glass transition temperature (T_{g}), maintaining the plastic substrate temperature for a first period; quenching the plastic substrate to a second temperature, and forming a color filter on the plastic substrate.

### BRIEF DESCRIPTION OF THE DRAWINGS

The invention can be more fully understood by reading the subsequent detailed description and examples with references made to the accompanying drawings, wherein:

FIG. 1 is a schematic view illustrating asymmetrical expansion and shrinkage of a plastic substrate after thermal processes;

FIG. 2 is a temperature profile of thermal treatment on a plastic substrate before color filters are formed thereon according to an embodiment of the invention;

FIG. 3 is a temperature profile of thermal treatment on a plastic substrate before color filters are formed thereon according to another embodiment of the invention; and

FIG. 4 shows color filters on a plastic substrate according to an embodiment of the invention.

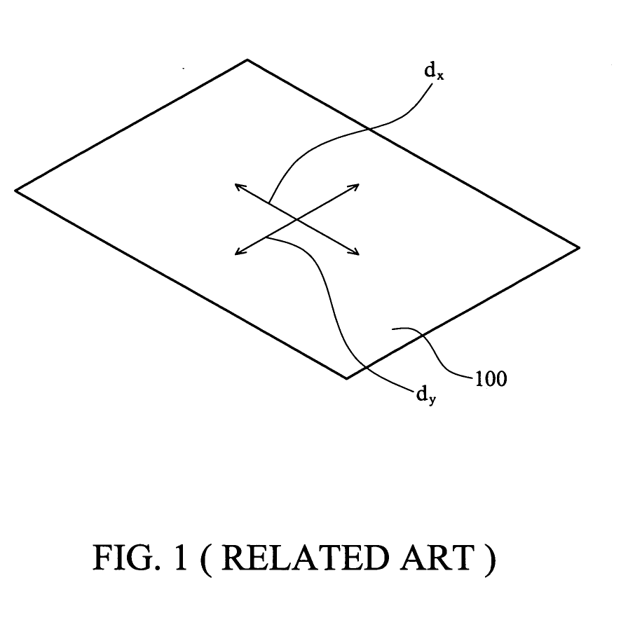

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention is directed to thermal treatment on a plastic substrate to prevent asymmetrical expansion and shrinkage during subsequent thermal processes, thereby providing color filters with high accuracy of dimension, position, and superposition.

According to an aspect of the invention, a thermal treatment is performed on the plastic substrate before color filter fabrication such that the plastic substrate retains microstructures from the high temperature state. The plastic substrate, after thermal treatment, exhibits reversible thermal expansion and shrinkage, simplifying color photoresist lithography.

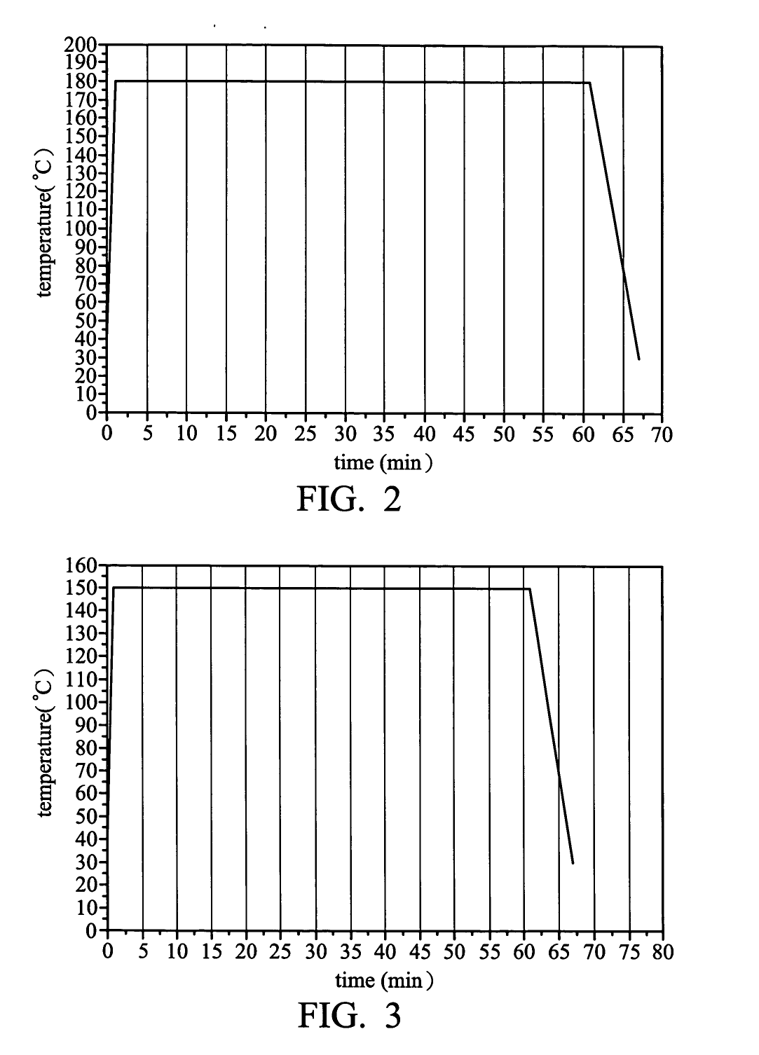

In an exemplary embodiment, a plastic substrate, preferably a polyethersulphone (PES) substrate, is provided for receiving color filters thereon. FIG. 2 is a temperature profile of thermal treatment on a plastic substrate before color filters are formed thereon according to an embodiment of the invention. The plastic substrate is heated to 180° C. for 1 hour, and then quenched to a room temperature. Cooling rate for the plastic substrate exceeds 5° C./min, thereby retaining microstructures from high temperature state. The microstructure of the plastic substrate after thermal treatment shows less than 50% crystallization. Red (R), green (G), and blue (B) color filters are sequentially formed on the substrate by spin coating. Each color filter fabrication comprises spin coating, soft bake, exposure, developing, and hard bake. Each color filter is hard baked at 180° C. for 1 hr.

Note that the plastic substrate comprises a polyethersulphone (PES) substrate, a polycarbonate (PC) substrate, a polyethylenetelephthalate (PET) substrate, or a polyethylenenaphthalate (PEN) substrate. The plastic substrate has a glass transition temperature (T_{g}), and is preferably heated at least 5° below the glass transition temperature (T_{g}). Alternatively, the plastic substrate has a melting temperature (Tₘ), and the plastic substrate is preferably heated at least 5° below the melting temperature (Tₘ).

FIG. 3 is a temperature profile of thermal treatment on a plastic substrate before color filters are formed thereon according to another embodiment of the invention. The plastic substrate is heated to 150° C. for 1 hour, and then quenched to room temperature. Red (R), green (G), and blue (B) color filters are sequentially formed on the substrate by spin coating. Each color filter fabrication comprises spin coating, soft bake, exposure, developing, and hard bake. Each color filter is hard baked at 150° C. for 1 hr.

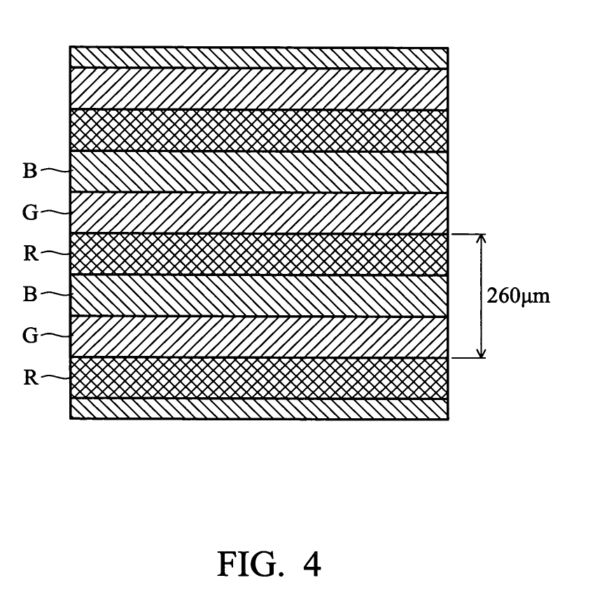

Color filters on a plastic substrate are shown in FIG. 4. Each color filter of red (R), green (G) and blue (B) has a pixel width of approximately 260 μm. Superposition between pixel regions is approximately less than 5 μm. Compared to conventional color filters on glass substrate, the color filters on a plastic substrate are competent.

The invention is advantageous in that a thermal treatment is performed on a plastic substrate before color filters are formed. The plastic substrate is quenched from a high temperature to room temperature, retaining microstructures from the high temperature state. The color filters on the plastic substrate comprise high accuracy of dimension, position, and superposition after thermal treatment.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of fabricating a plastic substrate for a liquid crystal display device, comprising:
providing a plastic substrate;
heating the plastic substrate to a first temperature and maintaining the first temperature; and
quenching the plastic substrate to a second temperature, retaining a microstructure of the plastic substrate from the first temperature.

2. The method as claimed in claim 1, wherein the plastic substrate comprises a polyethersulphone (PES) substrate, a polycarbonate (PC) substrate, a polyethylenetelephthalate (PET) substrate, or a polyethylenenaphthalate (PEN) substrate.

3. The method as claimed in claim 1, wherein the plastic substrate has a glass transition temperature (T_{g}), and wherein the first temperature is at least 5° below the glass transition temperature (T_{g}).

4. The method as claimed in claim 1, wherein the plastic substrate has a melting temperature (Tₘ), and wherein the first temperature is at least 5° below the melting temperature (Tₘ).

5. The method as claimed in claim 1, wherein the plastic substrate is maintained at the first temperature for less than 24 hours.

6. The method as claimed in claim 1, wherein the plastic substrate is cooled at a rate exceeding 5° C./min.

7. The method as claimed in claim 1, wherein the second temperature equals room temperature.

8. A method of fabricating a plastic substrate for a liquid crystal display device, comprising:
providing a plastic substrate;
heating the plastic substrate to at least 5° below the glass transition temperature (T_{g});
maintaining the plastic substrate for a first period;
quenching the plastic substrate to a second temperature; and
forming a color filter on the plastic substrate.

9. The method as claimed in claim 8, wherein the plastic substrate comprises a polyethersulphone (PES) substrate, a polycarbonate (PC) substrate, a polyethylenetelephthalate (PET) substrate, or a polyethylenenaphthalate (PEN) substrate.

10. The method as claimed in claim 8, wherein the plastic substrate is maintained at the first temperature for less than 24 hours.

11. The method as claimed in claim 8, wherein the plastic substrate is cooled at a rate exceeding 5° C./min.

12. The method as claimed in claim 8, wherein the color filter comprises photoresist patterns of red, green, and blue pixels, performed a bake procedure.

13. The method as claimed in claim 12, wherein the photoresist patterns of red, green, and blue pixels are baked at a temperature at least 5° below the glass transition temperature (T_{g}) of the plastic substrate.

14. The method as claimed in claim 12, wherein a dimension of the photoresist patterns of red, green, and blue pixels before the bake procedure is the same as a dimension of the photoresist patterns of red, green, and blue pixels after the bake procedure.
